(19) United States
(12) Patent Application Publication
(10) Pub. No.: US 2026/0270885 A1
(43) Pub. Date: Sep. 10, 2026

(54) MULTI-PORT DEVICE AND CONTROL METHOD THEREOF FOR REDUCING ALIEN PORT CROSSTALK NOISE

(71) Applicant: Realtek Semiconductor Corp., HsinChu (TW)

(72) Inventors: Jhe-Wei Li, HsinChu (TW); Yu-Tung Liao, HsinChu (TW); Wen-En Li, HsinChu (TW); Chung-Nan Cheng, HsinChu (TW); Cheng-Hsien Li, HsinChu (TW)

(73) Assignee: Realtek Semiconductor Corp., HsinChu (TW)

(21) Appl. No.: 19/302,075

(22) Filed: Aug. 17, 2025

(30) Foreign Application Priority Data
Mar. 4, 2025 (TW) 114107792

(51) Int. Cl. H04W 52/14; H04W 52/36

(52) U.S. Cl. CPC H04W 52/146; H04W 52/367

(57) ABSTRACT

A multi-port device includes a communication port, a signal-to-noise ratio monitor, and a transmission power controller. The communication port is coupled to a link partner. The signal-to-noise ratio monitor is coupled to the communication port, and is used to monitor a training signal-to-noise ratio in a training mode. The transmission power controller is coupled to the signal-to-noise ratio monitor, and is used to generate a power back-off for the link partner. The communication port is used to adjust the transmission power of the link partner according to the power back-off.

### BACKGROUND OF THE INVENTION

### 1. Field of the Invention

The invention relates to a communication system, and in particular, to a multi-port device and a control method thereof for reducing alien port crosstalk noise (APCN) in Ethernet.

2. Description of the Prior Art

In current multi-user wired communication systems, when multiple users connect simultaneously or sequentially, each communication port causes varying degrees of noise interference to other users, known as Alien Port Crosstalk Noise (APCN). Today, alien port crosstalk noise APCN has become an increasingly severe technical challenge. In communication systems with a large number of users, the APCN significantly degrades the overall quality and stability of transmission. With the rapid development of network communication technology, signal attenuation and interference issues caused by the APCN have become increasingly prominent.

Current industry technical solutions for alien port crosstalk noise APCN mainly focus on noise cancellation. However, in multi-user wired communication systems, due to the large number of users in each communication unit, the difficulty of thoroughly and effectively eliminating APCN is extremely high. More importantly, to achieve effective APCN cancellation, not only complex hardware computational capabilities are required, but the cost of receiving equipment would also be significantly increased. The coexistence of multiple data rate modes further complicates existing APCN cancellation algorithms, reducing their efficiency and practical viability. As a result, in multi-user Ethernet communication systems, striving for complete APCN elimination is neither cost-effective nor feasible.

### SUMMARY OF THE INVENTION

According to an embodiment of the invention, a control method for a multi-port device includes monitoring a training signal-to-noise ratio of a communication port in a training mode, generating a power back-off value for a link partner of the communication port based at least on the training signal-to-noise ratio; and the communication port adjusting a transmission power of the link partner according to the power back-off value.

According to another embodiment of the invention, a multi-port device includes a communication port, a signal-to-noise ratio monitor, and a transmission power controller. The communication port is coupled to a link partner. The signal-to-noise ratio monitor is coupled to the communication port and is used to monitor a training signal-to-noise ratio of the communication port in a training mode. The transmission power controller is coupled to the signal-to-noise ratio monitor and is used to generate a power back-off value for the link partner based at least on the training signal-to-noise ratio. The communication port is used to adjust a transmission power of the link partner according to the power back-off value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an architectural diagram of an Ethernet communication system according to an embodiment of the present invention.

FIG. 2 is a flowchart of a control method for the multi-port device in FIG. 1.

FIG. 3 is a flowchart of a transmission power control method for the multi-port device in FIG. 1.

FIG. 4 is a flowchart of another transmission power control method for the multi-port device in FIG. 1.

FIG. 5 is a flowchart of an equalizer parameter control method for the multi-port device in FIG. 1.

FIG. 6 is a schematic diagram showing the frequency bin power ratio of the communication port in FIG. 1.

FIG. 7 is a flowchart of another control method for the multi-port device in FIG. 1.

### DETAILED DESCRIPTION

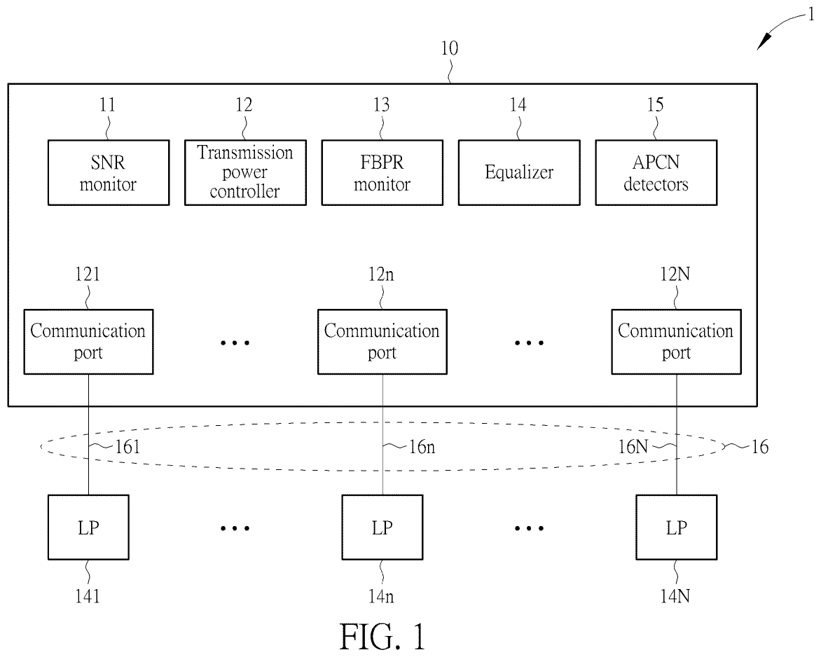

FIG. 1 is an architectural diagram of a communication system 1 according to an embodiment of the present invention. The communication system 1 may employ Ethernet technology to connect multiple user devices, thereby enabling data transmission among the multiple user devices. The communication system 1 may include a multi-port device 10 and link partners (LP) 141 to 14N, where N is a positive integer greater than 1. The link partners 141 to 14N may be connected to the multi-port device 10 through connection lines 161 to 16N. The connection lines 161 to 16N may be bundled together to form a single bundle cable 16. The multi-port device 10 may be an Ethernet switch or other network equipment capable of coupling to multiple user devices, and the link partners 141 to 14N may be computers, switches, routers, or other network equipment. The multi-port device 10 may continuously monitor the signal quality of each communication port and dynamically adjust the transmission power and/or the equalizer parameter of each communication port based on the signal quality, thereby improving the signal-to-noise ratio of communication ports with low communication quality and enhancing overall connection quality.

The multi-port device 10 may include communication ports 121 to 12N, respectively coupled to the link partners 141 to 14N. The communication ports 121 to 12N may perform data transmission with the link partners 141 to 14N respectively using various rate modes from Ethernet 10BASE-T to MultiGBASE-T. The multi-port device 10 may further include a signal-to-noise ratio (SNR) monitor 11, a transmission power controller 12, a frequency bin power ratio (FBPR) monitor 13, an equalizer 14, and an alien port crosstalk noise (APCN) detector 15 for monitoring and adjusting one of the communication ports 121 to 12N. In some embodiments, the multi-port device 10 may include N sets of SNR monitors 11, transmission power controllers 12, frequency bin power ratio monitors 13, equalizers 14, and APCN detectors 15, respectively corresponding to the communication ports 121 to 12N. For clarity, FIG. 1 only shows one set of components corresponding to a communication port 12n, where n is an integer from 1 to N, and each communication port may include 4 channels. Data transmission in the 4 channels employs a bidirectional communication mechanism. For example, the four channels between communication port 12n and its link partner 14n may be enabled to simultaneously perform bidirectional data exchange. The communication port 12n may send data to the link partner 14n via the 4 channels, while the link partner 14n may also transmit data to the communication port 12n via the 4 channels.

In the multi-port device 10, the communication port 12n is affected by electromagnetic interference and noise due to signal transmission from adjacent communication ports. Specifically, the communication ports 121 to 12(n−1) and 12(n+1) to 12N may all become potential noise sources. When the communication ports 121 to 12(n−1) and 12(n+1) to 12N perform signal transmission or reception, the transmission signals propagate through components of the multi-port device 10 (such as chassis or printed circuit boards) and the bundle cable, resulting in alien port crosstalk noise interference. The alien port crosstalk noise is superimposed on the communication port 12n, causing unstable noise interference at the receiving end of the communication port 12n, reducing the signal-to-noise ratio of the communication port 12n and affecting the overall communication quality of the communication system 1. When the communication port 12n is interfered with by other communication ports 121 to 12(n−1) and 12(n+1) to 12N, the communication port 12n may be referred to as a “Victim”, while the other communication ports 121 to 12(n−1) and 12(n+1) to 12N may be referred to as “Aggressors”. When the communication port 12n is not affected by interference from other communication ports 121 to 12(n−1) and 12(n+1) to 12N, the communication port 12n may be referred to as a “Stable neutral”. When the communication port 12n is performing data transmission, the communication port 12n may also become one of the “Aggressors” to the other communication ports 121 to 12(n−1) and 12(n+1) to 12N.

The SNR monitor 11 may be coupled to the communication port 12n and monitor the signal-to-noise ratio based on signals from the link partner 14n to estimate the signal quality of the communication port 12n. The signal-to-noise ratio may be defined as the ratio of signal power to noise power, measured in decibels (dB). A higher signal-to-noise ratio indicates that the signal is stronger relative to noise, resulting in better signal quality.

The transmission power controller 12 may be coupled to the SNR monitor 11 and generate a power back-off (PBO) value for the link partner 14n based at least on the signal-to-noise ratio of the communication port 12n. The communication port 12n may adjust the transmission power of the link partner 14n according to the power back-off value. The transmission power controller 12 may adjust the power back-off value by one or more fixed adjustment values. For example, if the fixed adjustment value is 2 dB, the transmission power controller 12 may adjust the power back-off value according to the signal-to-noise ratio in multiples of 2 dB (such as ±2 dB, ±4 dB, and other multiples). In some embodiments, the transmission power controller 12 may also use dynamic adjustment values to directly adjust the power back-off value to a target power back-off value or a target power back-off range. For example, if the target power back-off range is between 25 dB and 27 dB, and the signal-to-noise ratio is 22 dB, the transmission power controller 12 may use a power control signal to request the link partner 14n to perform fine transmission power adjustments to achieve the target power back-off value of 25 dB.

The FBPR monitor 13 may be coupled to the communication port 12n and monitor the FBPR of the communication port 12n based on signals from the link partner 14n. The equalizer 14 may be coupled to the FBPR monitor 13 and configure the equalizer parameter according to the FBPR of the communication port 12n. The equalizer 14 may adjust different frequency components in a signal, reduce inter-symbol interference (ISI) in the channel, thereby enhancing the signal quality of the communication port 12n. The equalizer parameter may be a step size parameter μ (mu), which controls the update speed of the coefficients of the equalizer 14 during the adaptation process. A larger step size parameter μ results in faster coefficient updates but may cause signal instability in the communication port 12n. A smaller step size parameter μ results in slower updates but more stable signals in the communication port 12n.

The operation modes of the multi-port device 10 are divided into a training mode and a data mode, each with specific functions and monitoring mechanisms. In the training mode, the multi-port device 10 may detect wireless environment characteristics and set the transmission power and the equalizer parameter accordingly. The SNR monitor 11 may monitor the signal-to-noise ratio of the communication port 12n to generate a training signal-to-noise ratio, while the APCN detector 15 is temporarily disabled. When the multi-port device 10 enters the data mode, the multi-port device 10 may perform actual data transmission. In the data mode, the SNR monitor 11 may continue to monitor the signal-to-noise ratio of the communication port 12n, but now generates a transmission signal-to-noise ratio. Meanwhile, the APCN detector 15 is enabled to switch the operation mode of the multi-port device 10. The APCN detector 15 may generate an alien port crosstalk noise level according to the transmission signal-to-noise ratio and the training signal-to-noise ratio, and determine whether to switch to the training mode according to the alien port crosstalk noise level and a noise threshold, thereby resetting the transmission power and the equalizer parameter to adapt to the changing wireless environment.

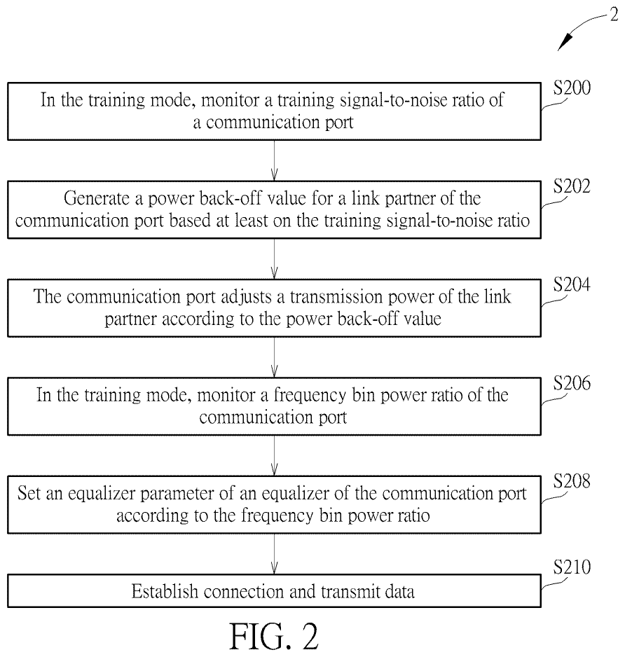

FIG. 2 is a flowchart of a control method 2 for the multi-port device 1. The control method 2 includes Steps S200 to S210 to adjust the transmission power and the equalizer parameter of each communication port according to the signal quality. Any reasonable technical modifications or step adjustments fall within the scope disclosed by the present invention. Steps S200 to S210 are detailed as follows:

Step S200: In the training mode, monitor a training signal-to-noise ratio of a communication port;

Step S202: Generate a power back-off value for a link partner of the communication port based at least on the training signal-to-noise ratio;

Step S204: The communication port adjusts a transmission power of the link partner according to the power back-off value;

Step S206: In the training mode, monitor a FBPR of the communication port;

Step S208: Set an equalizer parameter of an equalizer of the communication port according to the FBPR;

Step S210: Establish a connection and transmit data.

Steps S200 to S208 are executed in the training mode, while Step S210 is executed in the data mode. The control method 2 is now explained with reference to the communication system 1.

In Step S200, the SNR monitor 11 selects one channel from the 4 channels of the communication port 12n and generates a signal-to-noise ratio of the selected channel based on signals from the link partner 14n to represent the training signal-to-noise ratio of the communication port 12n. In some embodiments, the SNR monitor 11 may also separately generate 4 channel signal-to-noise ratios for the 4 channels in the communication port 12n. Due to different arrangement positions of transmission lines 161 to 16N and the 4 channels in individual communication ports, the 4 individual channels within a communication port may experience different alien port crosstalk noises, resulting in differences in signal-to-noise ratios of individual channels.

In Step S202, the transmission power controller 12 presets signal-to-noise ratio ranges for victim, aggressor, and stable neutral categories, and determines whether the communication port 12n or individual channels belong to victim, aggressor, or stable neutral categories based on which range the training signal-to-noise ratio or channel signal-to-noise ratio falls into. If the communication port 12n or individual channels belong to the victim category, the transmission power controller 12 may reduce their power back-off value; if the communication port 12n or individual channels belong to the aggressor category, the transmission power controller 12 may increase their power back-off value; if the communication port 12n or individual channels belong to the stable neutral category, the transmission power controller 12 may maintain their power back-off value.

In Step S204, in some embodiments, the communication port 12n adjusts the transmission power of the link partner 14n according to the power back-off value. The power back-off value may be for all channels or a single channel in the communication port 12n. If the power back-off value is for all channels in the communication port 12n, the link partner 14n may transmit signals to all channels in the communication port 12n according to the adjusted transmission power. If the power back-off value is for a specific channel in the communication port 12n, the communication port 12n may generate a power back-off value for the specific channel and transmit the power back-off value of the specific channel to the link partner 14n. After receiving the power back-off value of the specific channel, the link partner 14n adjusts the transmission power of the specific channel according to the power back-off value of the specific channel, thereby achieving dynamic power control.

In Step S206, the FBPR represents the ratio of power within a frequency bin to the preset total spectral power, used to measure the energy distribution of signals within the frequency bin. Alien port crosstalk noise may cause significant energy changes in specific frequency bins.

In Step S208, the equalizer parameter may be a step size parameter μ. When the FBPR shows significant energy changes in specific frequency bins, a larger step size parameter μ of the equalizer 14 may be set to quickly compensate for energy changes caused by alien port crosstalk noise. Conversely, when the FBPR shows stable energy in specific frequency bins, a smaller step size parameter μ of the equalizer 14 may be set to stabilize the signal of the communication port 12n.

In Step S210, after the transmission power and equalizer parameter settings are completed, the multi-port device 10 enters the data mode to establish connections and transmit data.

The multi-port device 10 employs the control method 2 to set transmission powers and equalizer parameters for different wireless environments in the training mode, ensuring communication quality and enhancing transmission performance.

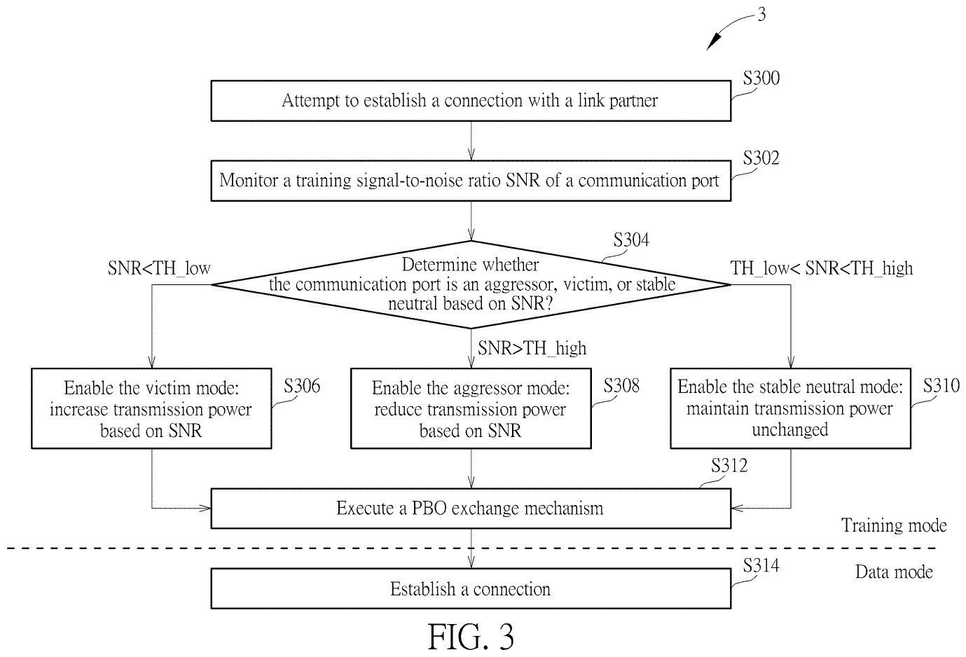

FIG. 3 is a flowchart of a transmission power control method 3 for the multi-port device 1. The control method 3 includes Steps S300 to S314 for adjusting the transmission power of each communication port according to signal quality. Since alien port crosstalk noise causes different interference noise levels at each communication port, multiple individual communication ports may respectively use the transmission power control method 3 to adjust their transmission power. Any reasonable technical modifications or step adjustments fall within the scope disclosed by the present invention. Steps S300 to S314 are detailed as follows:

Step S300: Attempt to establish a connection with a link partner;

Step S302: Monitor a training signal-to-noise ratio SNR of a communication port;

Step S304: Determine whether the communication port is an aggressor, victim, or stable neutral based at least on the training signal-to-noise ratio SNR; if the training signal-to-noise ratio SNR is less than a low threshold TH_low, the communication port is a victim, proceed to Step S306; if the training signal-to-noise ratio SNR is greater than a high threshold TH_high, the communication port is an aggressor, proceed to Step S308; if the training signal-to-noise ratio SNR is greater than the low threshold TH_low and less than the high threshold TH_high, the communication port is a stable neutral, proceed to Step S310;

Step S306: Enable the victim mode: increase transmission power based on the training signal-to-noise ratio SNR; proceed to Step S312;

Step S308: Enable the aggressor mode: reduce transmission power based on the training signal-to-noise ratio SNR; proceed to Step S312;

Step S310: Enable the stable neutral mode: maintain transmission power unchanged; proceed to Step S312;

Step S312: Execute a PBO exchange mechanism;

Step S314: Establish a connection.

Steps S300 to S312 are executed in the training mode, while Step S314 is executed in the data mode. The transmission power control method 3 is now explained with reference to the communication system 1.

In Step S300, the communication port 12n and the link partner 14n begin to establish a connection. Step S302 may be similar to Step S200 and will not be described again here.

In Step S304, the transmission power controller 12 compares the training signal-to-noise ratio SNR with the low threshold TH_low and/or high threshold TH_high to determine whether the communication port 12n is an aggressor, victim, or stable neutral. The low threshold TH_low may be set as the signal-to-noise ratio at which the communication port begins to lose packets, for example 25 dB. The high threshold TH_high may be greater than the low threshold TH_low. Specifically, the high threshold TH_high may be set as a value higher than the low threshold TH_low by one fixed adjustment value, for example, if the low threshold TH_low is 25 dB and the fixed adjustment value is 2 dB, then the high threshold TH_high may be set as 27 dB (i.e., 25+2).

When the training signal-to-noise ratio SNR is less than the low threshold TH_low, the communication port 12n is determined to be a victim, and the transmission power controller 12 loads a victim setting and reduces the power back-off value according to the training signal-to-noise ratio SNR, thereby increasing the transmission power of the link partner 14n and consequently increasing the training signal-to-noise ratio SNR (S306). The reduction value of the power back-off value may be positively correlated with the difference between the low threshold TH_low and the training signal-to-noise ratio SNR, and may be one or more fixed adjustment values.

When the training signal-to-noise ratio SNR is greater than the high threshold TH_high, the communication port 12n is determined to be an aggressor, and the transmission power controller 12 loads an aggressor setting and increases the power back-off value according to the training signal-to-noise ratio SNR, thereby reducing the transmission power of the link partner 14n and consequently reducing the training signal-to-noise ratio SNR (S308). The increase value of the power back-off value may be positively correlated with the difference between the training signal-to-noise ratio SNR and the high threshold TH_high, and may be one or more fixed adjustment values.

When the training signal-to-noise ratio SNR is between the low threshold TH_low and the high threshold TH_high, the communication port 12n is determined to be a stable neutral, and the transmission power controller 12 loads a stable neutral setting and maintains the original power back-off value (S310).

Subsequently, the communication port 12n sends the power back-off value to the link partner 14n through the PBO exchange mechanism (S312). The transmission power controller 12 may be a power back-off controller that transmits a power back-off request pbo_req to the link partner 14n through the communication port 12n, where the power back-off request pbo_req includes the power back-off value. Correspondingly, the link partner 14n adjusts the transmission power according to the power back-off request pbo_req and uses the adjusted transmission power to transmit data to the communication port 12n through the 4 channels (S314).

In one example, if the communication port 12n is determined to be a victim while communication ports 12(n−1) and 12(n+1) are determined to be aggressors, the communication port 12n receives excessive interference and has insufficient signal strength, while communication ports 12(n−1) and 12(n+1)generate excessive interference or have overly strong signals. Under this condition, the transmission power controller 12 of the communication port 12n may increase the transmission power of the link partner 14n to enhance signal strength and improve signal quality, while the transmission power controllers 12 of communication ports 12(n−1) and 12(n+1) may reduce the transmission power of link partners 14(n−1) and 14(n+1) to reduce interference. The transmission power control method 3 optimizes the signal strength and interference level of each communication port without affecting the overall performance of the communication system 1, thereby improving the stability and efficiency of the communication system 1.

The multi-port device 10 employs mechanisms defined by Ethernet communication protocols to dynamically adjust the power back-off value, with its operating principle based on analysis of signal energy received by the medium dependent interface (MDI) at the receiving end. Each different signal strength interval corresponds to a specific power back-off value. During specific implementation, the multi-port device 10 may first perform a series of signal processing on received signals, including eliminating interference signals through cancellers and using equalizers for signal compensation. After signal processing, the multi-port device 10 may calculate the signal-to-noise ratio of the processed signal and update the most suitable back-off value according to this signal-to-noise ratio value.

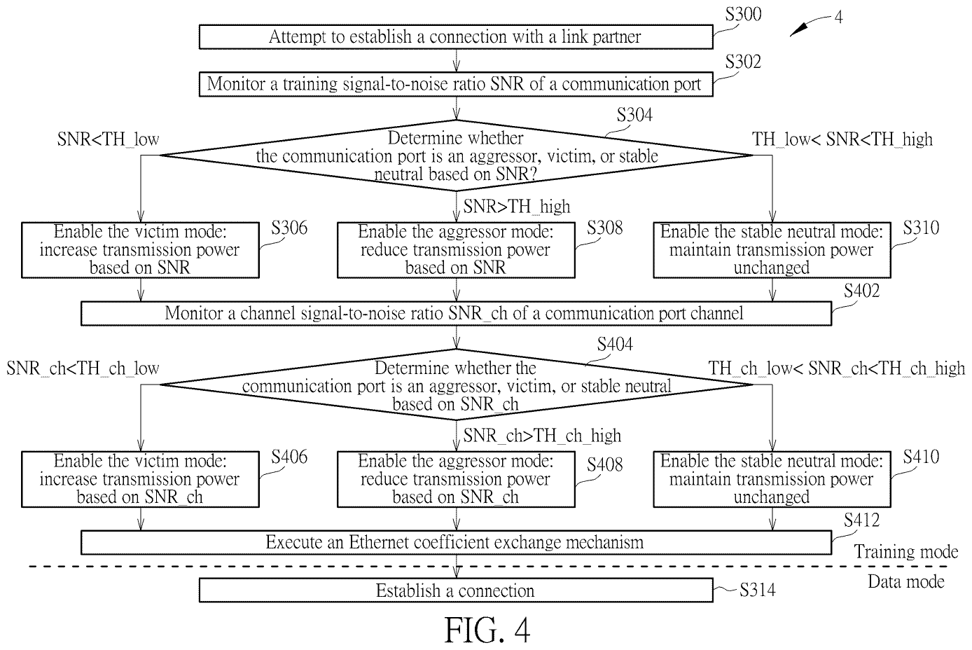

FIG. 4 is a flowchart of another transmission power control method 4 for the multi-port device 1. The control method 4 includes Steps S300 to S310, S402 to S412, and S314 for adjusting the transmission power of each channel of a communication port according to signal quality. Since alien port crosstalk noise causes different interference noise levels at individual channels of a communication port, the 4 channels of a communication port may respectively use the transmission power control method 4 to adjust their transmission power. Any reasonable technical modifications or step adjustments fall within the scope disclosed by the present invention. Steps S300 to S310, S402 to S412, and S314 are detailed as follows:

Step S300: Attempt to establish a connection with a link partner;

Step S302: Monitor a training signal-to-noise ratio SNR of a communication port;

Step S304: Determine whether the communication port is an aggressor, victim, or stable neutral based on the training signal-to-noise ratio SNR; if the training signal-to-noise ratio SNR is less than a low threshold TH_low, the communication port is a victim, proceed to Step S306; if the training signal-to-noise ratio SNR is greater than a high threshold TH_high, the communication port is an aggressor, proceed to Step S308; if the training signal-to-noise ratio SNR is greater than the low threshold TH_low and less than the high threshold TH_high, the communication port is a stable neutral, proceed to Step S310;

Step S306: Enable the victim mode: increase transmission power according to the training signal-to-noise ratio SNR; proceed to Step S402;

Step S308: Enable the aggressor mode: reduce transmission power according to the training signal-to-noise ratio SNR; proceed to Step S402;

Step S310: Enable the stable neutral mode: maintain transmission power unchanged; proceed to Step S402;

Step S402: Monitor a channel signal-to-noise ratio SNR_ch of a communication port channel;

Step S404: Determine whether the channel is an aggressor, victim, or stable neutral based on the channel signal-to-noise ratio SNR_ch; if the channel signal-to-noise ratio SNR_ch is less than a low channel threshold TH_ch_low, the channel is a victim, proceed to Step S406; if the channel signal-to-noise ratio SNR_ch is greater than a high channel threshold TH_ch_high, the channel is an aggressor, proceed to Step S408; if the channel signal-to-noise ratio SNR_ch is greater than the low channel threshold TH_ch_low and less than the high channel threshold TH_ch_high, the channel is a stable neutral, proceed to Step S312;

Step S406: Enable the victim mode: increase the channel transmission power according to the channel signal-to-noise ratio SNR_ch; proceed to Step S312;

Step S408: Enable the aggressor mode: reduce the channel transmission power according to the channel signal-to-noise ratio SNR_ch; proceed to Step S312;

Step S410: Enable the stable neutral mode: maintain the channel transmission power unchanged; proceed to Step S402;

Step S412: Execute an Ethernet coefficient exchange mechanism;

Step S314: Establish a connection.

Steps S300 to S310 and S402 to S412 are executed in the training mode, while Step S314 is executed in the data mode. Steps S300 to S310 and S314 in FIG. 4 are similar to those in FIG. 3, and their explanations will not be repeated here. The transmission power control method 4 is now explained with reference to the communication system 1.

In Step S402, the SNR monitor 11 separately detects the channel signal-to-noise ratio SNR_ch of each channel in the communication port 12n.

In Step S404, the transmission power controller 12 compares the channel signal-to-noise ratio SNR_ch with the low channel threshold TH_ch_low and/or high channel threshold TH_ch_high to determine whether individual channels of the communication port 12n are aggressors, victims, or stable neutrals. The low channel threshold TH_ch_low may be the same as the low threshold TH_low, set as the signal-to-noise ratio at which the communication port begins to lose packets, for example, 25 dB. The high channel threshold TH_ch_high may be the same as the high threshold TH_high, set as a value higher than the low channel threshold TH_ch_low by one fixed adjustment value, for example, if the low channel threshold TH_ch_low is 25 dB and the fixed adjustment value is 2 dB, then the high channel threshold TH_ch_high may be set as 27 dB (i.e., 25+2). In some embodiments, the low channel threshold TH_ch_low and high channel threshold TH_ch_high may be set according to actual requirements, for example, the low channel threshold TH_ch_low may also be different from the low threshold TH_low, and the high channel threshold TH_ch_high may also be different from the high threshold TH_high.

When the channel signal-to-noise ratio SNR_ch is less than the low channel threshold TH_ch_low, the channel of the communication port 12n is determined to be a victim, and the transmission power controller 12 loads the victim setting and reduces the power back-off value from Step S306, S308, or S310 according to the channel signal-to-noise ratio SNR_ch to generate a channel power back-off value for the channel of the communication port 12n. The transmission power controller 12 increases the transmission power of corresponding channels of the link partner 14n according to the channel power back-off value, thereby increasing the channel signal-to-noise ratio SNR_ch (S406). The reduction value of the channel power back-off value may be positively correlated with the difference between the low channel threshold TH_ch_low and the channel signal-to-noise ratio SNR_ch, and may be one or more fixed adjustment values.

When the channel signal-to-noise ratio SNR_ch is greater than the high channel threshold TH_ch_high, the channel of the communication port 12n is determined to be aggressors, and the transmission power controller 12 loads the aggressor setting and increases the power back-off value from Step S306, S308, or S310 according to the channel signal-to-noise ratio SNR_ch to generate a channel power back-off value for the channel of the communication port 12n. The transmission power controller 12 reduces the transmission power of the link partner 14n according to the channel power back-off value, thereby reducing the channel signal-to-noise ratio SNR_ch (S408). The increase value of the channel power back-off value may be positively correlated with the difference between the channel signal-to-noise ratio SNR_ch and the high channel threshold TH_ch_high, and may be one or more fixed adjustment values.

When the channel signal-to-noise ratio SNR_ch is between the low channel threshold TH_ch_low and the high channel threshold TH_ch_high, the channel of the communication port 12n is determined to be a stable neutral, and the transmission power controller 12 loads the stable neutral setting and uses the original power back-off value as the channel power back-off value (S410).

Subsequently, the communication port 12n sends the power back-off value to the link partner 14n through the Ethernet coefficient exchange mechanism (S412). Specifically, the transmission power controller 12 transmits channel power back-off requests tx_power_ch_req to the link partner 14n through individual channels of the communication port 12n, where the channel power back-off requests tx_power_ch_req include the channel power back-off values of individual channels. Correspondingly, the link partner 14n adjusts the transmission power of individual channels according to the channel power back-off requests tx_power_ch_req and uses the adjusted transmission power to transmit data to individual channels of the communication port 12n (S314).

The multi-port device 10 employs the control method 4 to set transmission power for the wireless environment of each channel of a communication port in the training mode, ensuring communication quality while enhancing transmission performance.

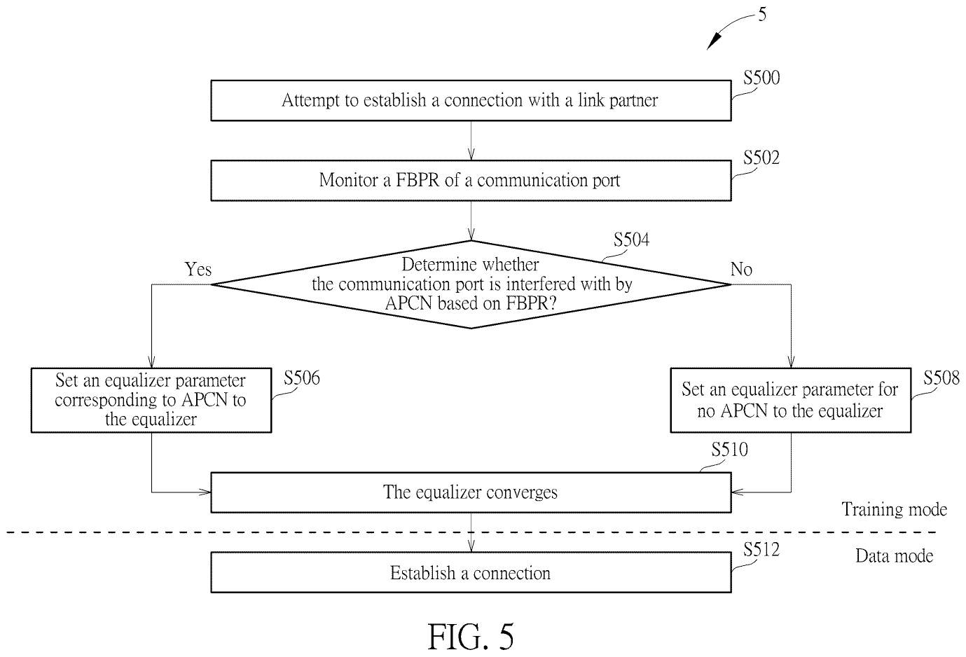

FIG. 5 is a flowchart of an equalizer parameter control method 5 for the multi-port device 1. The control method 5 includes Steps S500 to S512 for adjusting the equalizer parameter of each communication port according to FBPR. Any reasonable technical modifications or step adjustments fall within the scope disclosed by the present invention. Steps S500 to S512 are detailed as follows:

Step S500: Attempt to establish a connection with a link partner;

Step S502: Monitor FBPR of a communication port;

Step S504: Determine whether the communication port is interfered with by APCN based on the FBPR? if so, proceed to Step S506; if not, proceed to Step S508;

Step S506: Set an equalizer parameter corresponding to the APCN to the equalizer;

Step S508: Set an equalizer parameter for no APCN to the equalizer;

Step S510: The equalizer converges;

Step S512: Establish a connection.

Steps S500 to S510 are executed in the training mode, while Step S512 is executed in the data mode. Steps S500 and S512 are respectively similar to Steps S300 and S314, and their explanations will not be repeated here. The equalizer parameter control method 5 is now explained with reference to the communication system 1.

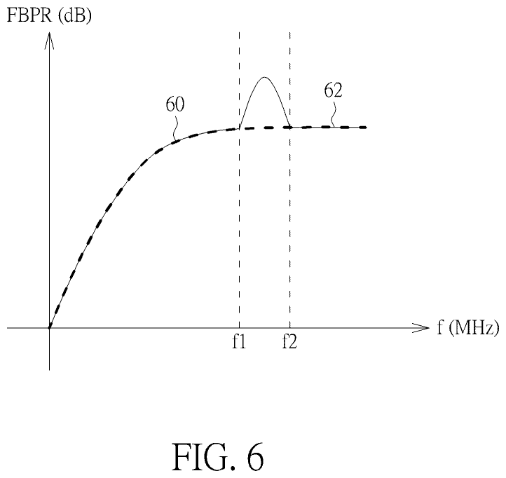

In Step S502, the multi-port device 10 filters signals from the link partner 14n, and then the FBPR monitor 13 performs frequency domain analysis on the filtered signals to generate the FBPR of the communication port 12n. FIG. 6 shows the FBPR of the communication port 12n, where the horizontal axis represents frequency f in units of megahertz (MHz), and the vertical axis represents FBPR in units of dB. Curve 60 is the ideal FBPR of the communication port 12n, while curve 62 is the actual FBPR of the communication port 12n. Except for the frequency band between frequencies f1 and f2, the actual FBPR curve 62 generally matches the ideal FBPR curve 60.

In Step S504, the multi-port device 10 compares the actual FBPR curve 62 with the ideal FBPR curve 60 to determine whether the communication port 12n is interfered with by APCN. Referring to FIG. 6, the multi-port device 10 determines that in the frequency band between frequencies f1 and f2, the communication port 12n is affected by APCN and deviates from the ideal FBPR curve 60, therefore the communication port 12n is interfered with by APCN, and thus continues to Step S506.

The equalizer parameter may be a step size parameter μ. In Step S506, since the communication port 12n is interfered with by APCN, the equalizer 14 increases the default step size parameter μ to generate APCN step size parameter μ′, thereby increasing the coefficient update speed of the equalizer 14 to accelerate convergence of the actual FBPR curve 62 to the ideal FBPR curve 60 (S510), thereby enhancing the ability of the communication port 12n to combat APCN. The value of APCN step size parameter μ′ may be positively correlated with the maximum absolute difference between the actual FBPR curve 62 and the ideal FBPR curve 60.

If the actual FBPR curve 62 and the ideal FBPR curve 60 match or only slightly mismatch within the preset spectral range, then the multi-port device 10 determines that the communication port 12n is not interfered with by APCN, therefore equalizer 14 loads the default step size parameter μ (S508), maintaining the original equalizer parameter of the equalizer 14. The default step size parameter μ is smaller than the APCN step size parameter μ′.

The multi-port device 10 employs the control method 5 to set equalizer parameters for different wireless environments in the training mode, ensuring communication quality and enhancing transmission performance.

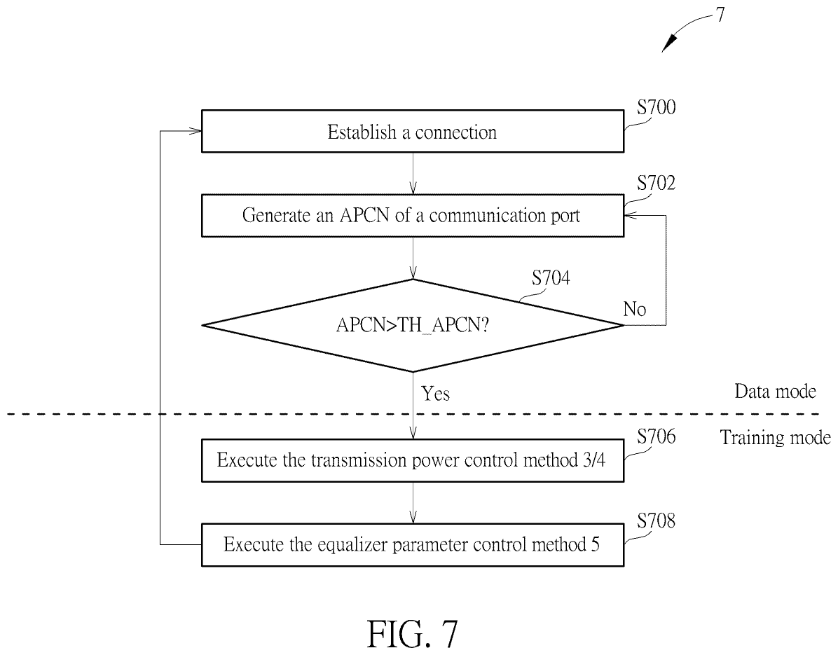

FIG. 7 is a flowchart of another control method 7 for the multi-port device 1. The control method 7 includes Steps S700 to S708 for continuously optimizing signal strength and interference levels of each communication port according to the current wireless environment. Any reasonable technical modifications or step adjustments fall within the scope disclosed by the present invention. Steps S700 to S708 are detailed as follows:

Step S700: Establish a connection;

Step S702: Generate an alien port crosstalk noise level APCN of a communication port;

Step S704: Determine whether the alien port crosstalk noise level APCN is greater than noise threshold TH_APCN. If so, proceed to Step S706; if not, return to Step S702;

Step S706: Execute the transmission power control method 3 or 4;

Step S708: Execute the equalizer parameter control method 5; proceed to Step S700.

Steps S700 to S704 are executed in the data mode, while Steps S706 and S708 are executed in the training mode. Step S700 in FIG. 7 is similar to Step S314 in FIG. 3, Step S706 in FIG. 7 is similar to the transmission power control method 3 or 4, and Step S708 in FIG. 7 is similar to the equalizer parameter control method 5, and their explanations will not be repeated here. The control method 7 is now explained with reference to the communication system 1.

In Step S700, the SNR monitor 11 may continuously monitor the signal-to-noise ratio of the communication port 12n in the data mode to generate and update the transmission signal-to-noise ratio. The SNR monitor 11 may record the last training signal-to-noise ratio in the training mode. Subsequently, the SNR monitor 11 may generate an alien port crosstalk noise level APCN according to the transmission signal-to-noise ratio and the training signal-to-noise ratio, and determine whether to switch to the training mode according to the alien port crosstalk noise level APCN and noise threshold TH_APCN. In some embodiments, the APCN detector 15 may calculate the absolute difference between the transmission signal-to-noise ratio and the training signal-to-noise ratio. If the absolute difference is greater than the noise threshold TH_APCN, then the change in transmission signal-to-noise ratio is excessive, and the SNR monitor 11 may switch to the training mode to reset the transmission power and the equalizer parameter of the communication port 12n (S706, S708). If the absolute difference is less than the noise threshold TH_APCN, then the change in transmission signal-to-noise ratio is minimal, and the SNR monitor 11 may maintain the data mode, allowing the communication port 12n to continue data transmission according to the set transmission power and equalizer parameters (S702).

In the communication system 1, the online and offline timing of each user (communication port) are dynamic. Consider the scenario where communication port 12n initiates a connection while the communication ports 121 through 12(n−1) are already online and the communication ports 12(n+1) through 12N remain offline. During the connection process of the communication port 12n, the FBPR monitor 13 estimates the FBPR, which incorporates the APCN from the currently connected communication ports 121 through 12(n−1). Using this channel estimation, the multi-port device 10 computes the equalizer parameter for the equalizer 14 and establishes the connection for the communication port 12n. At a certain time point, the communication port 12(n+1) comes online and introduces additional APCN onto the communication port 12n. Since the equalizer parameter of the communication port 12n is calculated prior to the communication port 12(n+1) coming online, the value of the equalizer parameter becomes suboptimal for the changed condition. Therefore, the communication port 12n requires updated an equalizer parameter to restore optimal performance.

In such a situation, the control method 7 continuously monitors the noise fluctuations at each communication port. When an unexpected increase in APCN is detected, the multi-port device 10 re-enters the training mode to adjust the transmission power and the equalizer parameter of the communication port 12n, enabling the equalizer 14 to reconverge, allowing the communication port 12n to quickly and accurately adapt to the changed wireless environment, thereby maintaining optimal connection quality.

The multi-port device 10 employs the control method 7 to set the transmission power for the wireless environment of each channel of a communication port in the training mode, ensuring communication quality while enhancing transmission performance.

The embodiments of the present invention disclose a multi-port device 1 and control methods 2-5 and 7, which dynamically adjust the transmission powers and/or the equalizer parameter of each communication port based on the signal quality in the current wireless environment. This adaptive control enhances the signal-to-noise ratio (SNR) of ports experiencing unfavored communication quality, thereby improving overall connection performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for a multi-port device comprising:
monitoring a training signal-to-noise ratio of a communication port in a training mode;
generating a power back-off value for a link partner of the communication port based at least on the training signal-to-noise ratio; and
the communication port adjusting a transmission power of the link partner according to the power back-off value.

2. The method of claim 1, wherein generating the power back-off value for the link partner of the communication port based at least on the training signal-to-noise ratio comprises:
reducing the power back-off value if the training signal-to-noise ratio is less than a low threshold.

3. The method of claim 1, wherein generating the power back-off value for the link partner of the communication port based at least on the training signal-to-noise ratio comprises:
increasing the power back-off value if the training signal-to-noise ratio exceeds a high threshold.

4. The method of claim 1, wherein the communication port adjusting the transmission power of the link partner according to the power back-off value comprises:
the communication port transmitting the power back-off value to the link partner.

5. The method of claim 1, further comprising:
monitoring a channel signal-to-noise ratio of a channel of the communication port in the training mode; and
generating a channel power back-off value for the channel of the link partner based at least on the channel signal-to-noise ratio;
wherein the communication port adjusting the transmission power of the link partner according to the power back-off value comprises:
the communication port transmitting the channel power back-off value to the link partner to adjust a transmission power of the channel of the link partner.

6. The method of claim 5, wherein generating the channel power back-off value for the channel of the link partner based at least on the channel signal-to-noise ratio comprises:
reducing the power back-off value to generate the channel power back-off value if the channel signal-to-noise ratio is less than a low threshold.

7. The method of claim 5, wherein generating the channel power back-off value for the channel of the link partner based at least on the channel signal-to-noise ratio comprises:
increasing the power back-off value to generate the channel power back-off value if the channel signal-to-noise ratio is greater than a high threshold.

8. The method of claim 1, further comprising:
monitoring a frequency bin power ratio of the communication port in the training mode; and
setting an equalizer parameter of an equalizer of the communication port according to the frequency bin power ratio.

9. The method of claim 8, wherein the equalizer parameter is an equalizer step size.

10. The method of claim 1, further comprising:
monitoring a transmission signal-to-noise ratio of the communication port in a data mode;
generating an alien port crosstalk noise level according to the transmission signal-to-noise ratio and the training signal-to-noise ratio; and
determining whether to switch to the training mode according to the alien port crosstalk noise level and a noise threshold.

11. A multi-port device comprising:
a communication port coupled to a link partner;
a signal-to-noise ratio monitor coupled to the communication port and configured to monitor a training signal-to-noise ratio of the communication port in a training mode; and
a transmission power controller coupled to the signal-to-noise ratio monitor and configured to generate a power back-off value for the link partner based at least on the training signal-to-noise ratio;
wherein the communication port is configured to adjust a transmission power of the link partner according to the power back-off value.

12. The multi-port device of claim 11, wherein the transmission power controller is configured to reduce the power back-off value if the training signal-to-noise ratio is less than a low threshold.

13. The multi-port device of claim 11, wherein the transmission power controller is configured to increase the power back-off value if the training signal-to-noise ratio is greater than a high threshold.

14. The multi-port device of claim 11, wherein the communication port is configured to transmit the power back-off value to the link partner.

15. The multi-port device of claim 11, wherein:
the signal-to-noise ratio monitor is further configured to monitor a channel signal-to-noise ratio of a channel of the communication port in the training mode;
the transmission power controller is further configured to generate a channel power back-off value for the channel of the link partner based at least on the channel signal-to-noise ratio; and
the communication port is configured to transmit the channel power back-off value to the link partner to adjust a transmission power of the channel of the link partner.

16. The multi-port device of claim 15, wherein the transmission power controller is configured to reduce the power back-off value to generate the channel power back-off value if the channel signal-to-noise ratio is less than a low threshold.

17. The multi-port device of claim 15, wherein the transmission power controller is configured to increase the power back-off value to generate the channel power back-off value if the channel signal-to-noise ratio is greater than a high threshold.

18. The multi-port device of claim 11, further comprising:
a frequency bin power ratio monitor coupled to the communication port and configured to monitor a frequency bin power ratio of the communication port in the training mode; and
an equalizer coupled to the frequency bin power ratio monitor and configured to receive an equalizer parameter according to the frequency bin power ratio.

19. The multi-port device of claim 18, wherein the equalizer parameter is an equalizer step size.

20. The multi-port device of claim 11, wherein:
the signal-to-noise ratio monitor is further configured to monitor a transmission signal-to-noise ratio of the communication port in a data mode; and
the multi-port device further comprises an alien port crosstalk noise (APCN) detector coupled to the signal-to-noise ratio monitor and configured to generate an alien port crosstalk noise level according to the transmission signal-to-noise ratio and the training signal-to-noise ratio, and to determine whether to switch to the training mode according to the alien port crosstalk noise level and a noise threshold.
